(19) United States
(12) Patent Application Publication
(10) Pub. No.: US 2008/0247529 A1
(43) Pub. Date: Oct. 9, 2008

(54) Incoming Call Classification And Disposition

(75) Inventors: William F. Barton, Harvard, MA (US); Francisco M. Galanes, Wellesley, MA (US); Anand Ramakrishna, Redmond, WA (US); Tal Saraf, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/695,810

(22) Filed: Apr. 3, 2007

(51) Int. Cl. H04M 3/42

(52) U.S. Cl. 379/211.01

(57) ABSTRACT

Incoming calls or other messages are automatically categorized and handled based on information gleaned from one or more of the following sources: user location (available contact modes, available contact devices), user-specified preferences, a dialog with the caller, and direct interaction with the callee over a non-telephonic channel. Based on speech recognition of dialog information with the caller and one or more of presence or location information, static rules and direct callee interaction, the disposition of an incoming call is determined by an automated Personal Virtual Assistant.

### BACKGROUND

Telephony encompasses the general use of equipment to provide voice communication over a distance. Plain old telephone service, or POTS, is the most basic form of residential and small business telephone service. POTS became available soon after the telephone system was introduced in the late 19th century and, from the standpoint of the user, has existed more or less unchanged ever since. POTS services include bi-directional or full duplex voice path with a limited frequency range, a dial tone and ringing signal, subscriber dialing, operator services such as directory assistance, and long distance and conference calling. During the 1970s and 1980s, new network services became available due to the creation of electronic telephone exchanges and computerization. New services included voice mail, caller identification, call waiting, reminder calls and other similar services.

Advances in digital electronics have revolutionized telephony by providing alternate means of voice communication than those provided by traditional (analog) telephone systems. IP Telephony is a form of telephony which uses the TCP/IP protocol popularized by the Internet to transmit digitized voice data. The routing of voice conversations over the Internet or through other IP networks is also called VoIP (Voice over Internet Protocol). Digital telephony was introduced to improve voice services, but was subsequently found to be very useful in the creation of new network services because it can transfer data quickly over telephone lines. Computer Telephony Integration (CTI) enables a computer to control phone functions such as making and receiving voice, fax, and data calls. The Session Initiation Protocol (SIP) is a signaling protocol used for creating, modifying and terminating sessions (voice or video calls) with one or more participants. Sessions include Internet telephone calls, multimedia distribution and multimedia conferences. Development of the SIP protocol was motivated by the need for a signaling and call setup protocol for IP-based communications that could support the call processing functions and features present in the public switched telephone network (PSTN) using proxy servers and user agents.

All the advances in telephony, however, have not solved some very basic problems associated with actually reaching a desired party. It is often difficult to reach people by telephone. Furthermore, a ringing telephone conveys very little information about the call to the callee and very little information about the callee to the caller. For example, the caller is unlikely to know anything about the current activities of the callee at the time of the call. The callee may be at her desk and able to take the call or in a meeting or out of the office. Likewise, the callee is unlikely to know much about the incoming call. (“It is my wife, but I'm in a meeting—I wonder if it is urgent?”) The below addresses these and other problems.

### SUMMARY

Incoming calls or other messages are automatically categorized and processed based on information gleaned from one or more of the following sources: information available from the telephone system, from user location or presence information which includes information concerning available contact modes (voice or text) and available contact devices, from global (enterprise-wide) and user-specified preferences concerning how a call from a particular caller, groups of callers or classification of call is handled, information gleaned from an automated speech recognition (ASR) processed dialog with the caller, and direct interaction with the callee over a telephonic or non-telephonic channel. Based on the information obtained from one or a combination of sources, the disposition of an incoming call is determined and acted upon by an automated Personal Virtual Assistant.

### BRIEF DESCRIPTION OF THE DRAWINGS

In the drawings:

FIG. 1 is a block diagram illustrating an exemplary computing environment in which aspects of the invention may be implemented;

FIG. 2 is a block diagram of a system for classification and disposition of incoming calls in accordance with some embodiments of the invention;

FIG. 3 is a flow diagram of a method for classification and disposition of incoming calls in accordance with some embodiments of the invention; and

FIG. 4 is another flow diagram of a method for classification and disposition of incoming calls in accordance with some embodiments of the invention.

### DETAILED DESCRIPTION

### Overview

A robust voice user interface, (called herein the Personal Virtual Assistant or PVA) may be hosted on an enterprise communications server operating in real time. The communications server integrates with a number of known corporate telephone systems but can process any type of voice channel. The PVA can provide the following services: caller identification, mixed-initiative multimodal call screening and negotiation, personalized call routing, structured message-taking, cross-modal messaging, voice dialing and voice-enabled message access and configuration. The PVA can communicate with the caller, classify the call and process, route or handle the disposition of the incoming call.

When a caller dials a callee's telephone number using a first communication channel, (callee is a PVA user) in some embodiments of the invention, the PVA application answers the caller's call (over a first communication channel) and prompts the caller to identify himself/herself. An automated speech recognition component may be used to process the caller's voice input. The caller may be asked the relative importance of the call, and other information such as the subject or type of the call and so on. A second communication channel with the callee may be automatically initiated by the PVA while the incoming telephone call is being processed. An indication that the callee's PVA is trying to reach the callee may be sent to the callee. The indication may include one or more of the following: the name of the caller, the relative importance of the call, the subject of the call, type of call or other information. In some embodiments of the invention, a notification window sometimes referred to as a toast may appear when an incoming email is detected or when one of the user's contacts becomes available. The location in which the notification appears may be standardized: for example, the toast may appear in a particular location such as the lower right side of the desktop when an incoming email is detected or when one of the user's contacts becomes available. It will be apparent to those skilled in the art that the particular location chosen to for the standardized location is not important and thus may be the lower or upper right or left side, center, or any suitable location. Typically the toast appears briefly and then spontaneously disappears. In response to instructions received from direct interaction of the PVA with the callee or to default instructions stored in a rules database (enterprise wide (generic) or caller-specific) for the callee, the PVA may forward the call to a specific voice-capable destination, generate a structured voicemail, send a text alert to a suitable PVA user client, establish a dialog including a (potentially) cross-modal dialog between a voice-only caller and a text-only PVA user client, or transfer the call to another user. The PVA may support dialing from desktop and remote phones.

For example, in a greeting phase of call negotiation, a call may be answered, and the PVA may issue a user-configurable greeting, perhaps giving the caller an indication that the caller is interacting with an automated system (e.g. “Hi, this is Bill's Virtual Assistant, please speak clearly.”). In the next phase of call negotiation, the caller may be identified. The PVA may interact with the caller to identify the caller either as a recognized member of the callee's Contacts list or as someone who is not recognized, that is, who is not a member of the callee's Contacts list. An initial guess may be derived from the call's ANI (Automatic Number Identification is a feature of telephony intelligent network services which permits subscribers to display or capture the telephone numbers of calling parties), however, the ANI is often not available, not recognized (i.e., not in the Contacts list), ambiguous (associated with multiple contacts), or misleading (e.g., the caller is using a telephone belonging to someone else). The PVA can prompt the caller to identify himself/herself and confirm or correct the elicited or ANI-derived identity, enabling caller-specific handling logic to be performed, instead of caller-independent handling logic, which is the norm today.

Before alerting the callee to the call, the PVA may ask the caller to provide information which enables the PVA to characterize the call (phase three of call negotiation). For example, a caller from a specific contact group (e.g., contact group is Family, Supervisor, or Customer, etc.) may be able to provide information so that the call is handled in a particular way by the PVA. (For example, a member of a Family or Supervisor contact group may be extended the opportunity to say the call is urgent to facilitate special call handling.) In the fourth phase of call negotiation, the PVA may play an announcement that was specified by the PVA user (the callee, in this example) to the caller such as “Let me see if Bill is at his desk” (that is, by his telephone) and may use a combination of caller identity, caller characterization, callee presence information and configured rules to attempt to alert the callee to the call and to obtain the callee's instructions for handling the call. For example, if the callee's presence information indicates that the callee is at his/her desk, the callee's desktop phone may ring, and a desktop alert such as a popup on the callee's computer can present the incoming call information with application call-handling choices (e.g., “Bill, Larry is calling and says it is urgent. Should I: 1) Take a message 2) Take a message and say you will call back in [N] minutes 3) Transfer call to [Cellular Telephone]”). The callee has the option to pick up the desktop telephone to take the call directly or can communicate with the PVA via the popup or other channels. If the callee is not at his desk but can be contacted by alternate means, such as by an interactive text channel such as Instant Messenger (IM) or the like, a similar alert and list of options can be sent via the interactive text channel, through which the election may be made. If the callee is already on the desktop telephone but is not online (i.e., not able to receive a desktop alert), the callee can respond to a call-waiting ring by pressing a key on the telephone which causes the PVA to play an audible message that includes the call information, so that the callee can indicate how the call should be handled before returning to the original call (i.e., the call the callee was taking when he received the call-waiting ring). In each of these cases, the PVA may wait for the callee election, (with a suitable timeout period after which the PVA continues without callee election, according to specified default rules for such circumstances), before proceeding to the next phase of call negotiation. The next phase of call negotiation is caller election.

In the caller election phase, the PVA may present a list of call handling options to the caller. The list may include one or more options. If there is only one available option, the PVA may inform the caller before proceeding without waiting for caller input (e.g. “Bill cannot take any calls right now, but he would like you to leave a message, and he will call you back in 30 minutes.” and proceed to the voicemail prompt, or alternatively, the PVA may merely proceed. If there are two or more choices, the PVA may prompt the caller to select one of the choices, (e.g., “Bill is away from his desk. Would you like me to forward your call to his cell, take a message and send him an alert, or set up an interactive text session with him?”). If one of the callee-specified ways to handle the call is to transfer the call, the PVA may include the name of the destination user if there is only one specified on the transfer list (“ . . . or be transferred to [name]”) or, if there are multiple destination users specified on the transfer list, the PVA may give a generic prompt such as “ . . . or be transferred to someone who can help you.”) The destination user may be a PVA user or may alternatively, be someone who is not a PVA user. The degree of access offered to the caller may reflect static rules in place for that particular caller and/or may depend on caller-specific instructions provided by the alerted callee to the PVA. Default rules may stipulate that leaving a message is always an option.

In some embodiments of the invention, the PVA may learn from interactions with callers. For example if a caller has elected to use cross modal communications for the past [N] times (may be specifiable by the PVA user) when calling a callee, this mode of communication may become the default for that caller-callee pair. Other alternatives may be removed unless the PVA user (or one of the PVA users in the case that both the caller and the callee are PVA users) elects to change the mode of communication for the caller/callee pair.

Call handling includes call forwarding, saving a structured voicemail and sending an alert, instantiating an instant (cross-modal) voice messenger session with the callee and call transfer. Voice-only calls may be forwarded to voice-capable destinations such as to the callee's mobile telephone or other communications device. A text alert providing “envelope” information (information about when the call was received) may be delivered to one or more of the callee's available text-mode clients. The caller may be guided through the process of leaving a structured voicemail, so that voicemail-waiting alerts are able to provide more information to the callee. In addition to the identity and call characterization described above, the caller may be prompted for the general topic of the call (e.g., “What is this regarding?”) and the best time and means for the callee to reply. The PVA may also prompt the caller to record a free-format body of the message. The structured information may be included in any text-mode or voicemail-waiting alert which the PVA sends to the callee, facilitating timely and efficient message retrieval.

A cross-modal “instant voice messenger” conversation may be mediated by the PVA between a voice-only caller and a text-only callee (the callee is a PVA user). The PVA may prompt the caller to dictate a message, which may then be converted to text using a large vocabulary recognizer that has been tuned to an interactive text-messaging service such as Instant Messenger. The text of the caller's message may be sent to the callee's interactive text-messaging service (e.g., to an IM client) and the callee's reply may be played back to the caller using the PVA's text-to-speech (TTS) engine. Thus the callee is able to “chat” using an interactive text messaging service with a voice-only caller in situations where it would be disruptive or otherwise undesirable to accept a voice call and engage in an audible conversation.

Call transfer provides preferential call handling for priority calls when the callee is unable to take the call directly or does not want a caller to leave a message (perhaps because the callee will be out of touch for an extended period of time). The PVA may be configured to provide the caller with a list of alternative callees to whom the caller may be directed. The original callee may have recorded an explanatory prompt (“I will be out of the office until May 15^{th}. For questions about release schedules, ask for Ray; for questions about features, ask for Chris . . . How may I direct your call?”)

### Exemplary Computing Environment

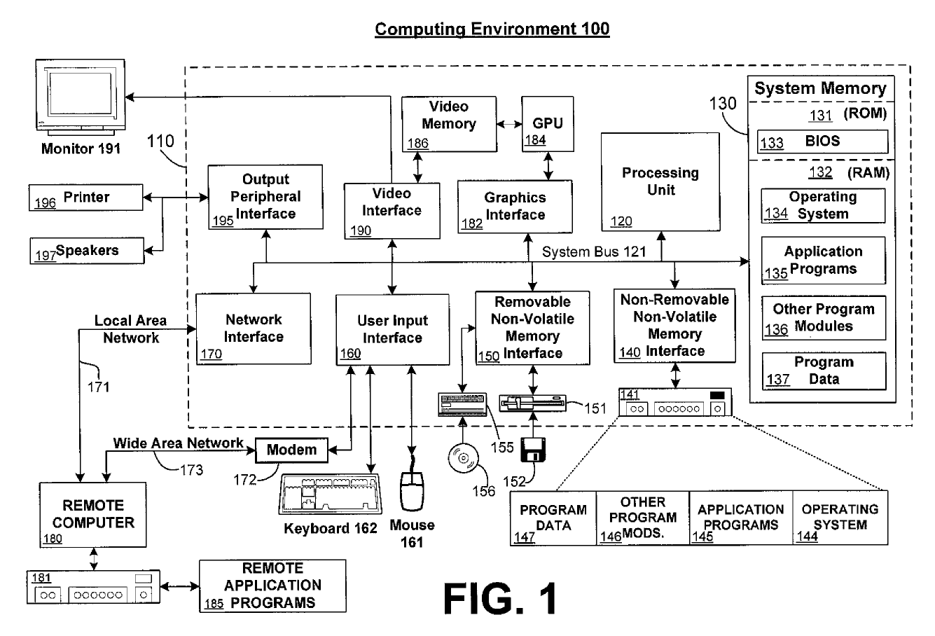

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

### Incoming Call Classification and Disposition

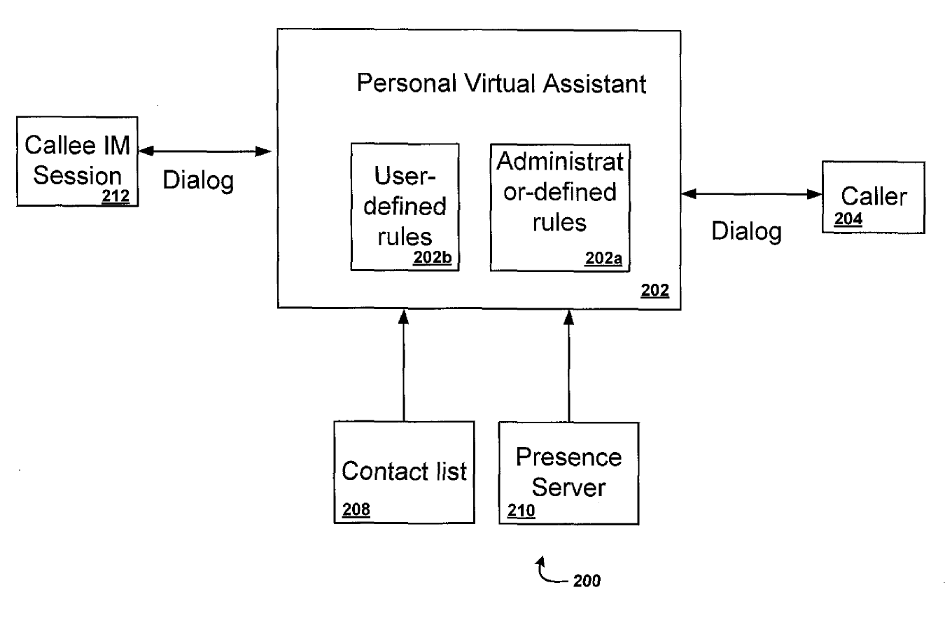

FIG. 2 illustrates an exemplary system 200 for the classification and disposition of incoming calls in accordance with embodiments of the invention. System 200 may reside on one or more computers such as the one illustrated above with respect to FIG. 1. Personal Virtual Assistant (PVA) 202 may include one or more components including a (not shown) speech server comprising a conversational workflow engine including a language processing core and workflow-based APIs and a communication server such as Microsoft's Live Communication Server. A caller 204 may make a telephone call to a callee 212 (a PVA user) via any telephony communications device including a telephone, cellular telephone, smart telephone, PDA, interactive text messaging software or any PC based soft-telephone. Thus, caller 204 may represent any SIP (Session Initiation Protocol) telephony client including a communications server client such as a Microsoft Office Communicator client, a POTS telephone using VoIP gateways or any other telephone or communications device using the SIP protocol. Caller 204 may represent a PVA user, and thus the incoming call may be a call placed by another PVA. Alternatively, caller 204 may be a non-PVA user. Call-handling graphical user interfaces may be provided to complement the voice interface and handle the text side of cross-modal interactions. Embodiments of the invention include one or more of the following areas of speech-enabled functionality: incoming call negotiation, call handling, voice mailbox access, voice dialing and PVA configuration. Incoming call negotiation may include one or more of the following: caller identification, call characterization, user alert and election and user election. PVA 202 may receive information such as contact information from a contact database 208 and rules including generalized (e.g., administrator-defined) rules 202a and user-specific rules 202b. For example, a PVA user such as callee 212 may specify rules concerning how all or some portion of incoming calls are to be handled (e.g., “If I do not answer my telephone by the fourth ring, transfer my call to my assistant, Kathleen.” “If the caller identifies himself as “Sam”, tell him not to call me any more and hang up!”). Rules may apply to all calls received by the callee, may apply to all calls of a particular type, may apply to all calls from a particular (specified) caller, may apply to all calls from a specified group of callers, and so on. Information about the whereabouts of the callee 212 may be provided by a presence server 210. Presence information can be obtained by information available from other applications running on the computer and may include information concerning whether the PVA user is logged onto his computer, whether or not the PVA is logged onto an interactive text messaging application, information available from a scheduling or calendar application

While caller 204 may or may not be a PVA user, in FIG. 2, caller 204 is calling a PVA user (e.g., PVA user callee 212). In response to receiving caller 204's call to PVA user 212, a dialog with PVA 202 may be initiated by PVA 202. During phase one (the greeting phase) PVA 202 may greet the caller and (optionally) indicate that the PVA is an automated speech processor. Suppose, for example, that caller Larry calls PVA user Bill's desktop telephone by dialing Bill's telephone number. After a specified number of rings, the PVA may answer the call and greet the caller, e.g., PVA: “Hi, this is Bill's Virtual Assistant; please speak clearly.”

PVA 202 may receive information from the IP network concerning the identity of the caller. For example, the ANI feature of the IP network may deliver the telephone number of the telephone Larry is using to PVA 202. The PVA 202 may examine Contact list 208 for the number received from the network. If the received number is found in the Contact list 208 and (optionally) is unique, the PVA 202 may attempt to confirm that the caller is the person associated with the number, e.g. PVA: “Is this Larry calling?” If this is Larry calling, he may confirm his identity, e.g. Larry: “Yes”. Upon receiving voice input from caller 204, a speech recognition component of PVA 202 is activated. The dialog that collects the information from the caller may be open-ended and may make use of mixed-initiative dialog strategies where the speech recognizer attempts to make a best-guess at name, topic, etc. based on global grammars or it may implement a system-driven strategy with categories for selection based on predefined menus such as PVA: “What is the topic? Please say ‘work-related’, ‘non-work related’ or ‘confidential’ enabling much simpler grammars to be used. The dialog may be enhanced by sharing the presence of the callee with the caller, if the callee's rules allow this information to be shared with the caller. In this case, an extra step may be added that tells the caller that the callee is [wherever the callee is, based on presence information from the presence server] before continuing on. When the identity of the caller is established, processing continues to the next phase (negotiation). If the identity of the caller has not yet been established, PVA 202 may attempt to confirm identity. For example, suppose it is someone else, (perhaps using Larry's phone), the caller may identify himself, e.g. “No, this is Tal, on Larry's telephone.” The PVA 202 may check for the received name (e.g. “Tal”) in the Contact list 208. If the received name is found in the Contact list 208 and is unique, the PVA 202 may determine that identity has been confirmed and go on to the negotiation phase. In some embodiments of the invention, the PVA makes use of speech recognition software to get a string (text) representation of the voice contact name provided, and uses the string to find the contact object by name. The PVA 202 may determine that the received name is not unique and may reprompt for identity. If no match can be found in the Contact List 208, PVA 202 may conclude that the caller is unknown, record the non-Contact name and continue on to the negotiation phase. If no ANI information is available, PVA 202 may prompt for identity, (e.g., “May I ask who is calling?”) and then follow the rest of the procedure described above. If during the above described process, the name is not recognized with a high degree of confidence, the PVA 202 may reprompt, e.g., PVA: “I did not understand you, please repeat your name?”

During the classification portion of the negotiation phase, the urgency of the call may be elicited from the caller. For example, the PVA 202 may ask “Is your call urgent?” and use the received information to classify the call to determine how to handle the call, as described more fully below. Other information concerning the classification of the call may be solicited by the PVA. For example, the caller may be asked if the call relates to a personal or a work matter and so on. In some embodiments of the invention, members of the Contacts list 208 can be grouped (e.g., “Florence” is a member of the Family group, “Larry” is a member of the Supervisor group, etc.) and only some groups may be prompted for urgency information, based on user-specified rules.

During a user alert and election portion of the negotiation phase, the location or presence of the callee (PVA user) is determined. If the PVA user is at his desk, logged into his computer and not using the telephone when the call is received, PVA 202 may cause the telephone to ring, and display a popup message on the PVA user's computer screen. An example of a popup message may be, PVA: “[name of caller] is calling and he says it is urgent.” PVA 202 may provide a list of options including but not limited to: PVA: “(1) Take Message, will reply in [N] minutes (2) Transfer to [name specified in user rules]. The PVA user in some embodiments of the invention has one or more of the following options: [Case 1] The callee picks up the telephone to talk to the caller. [Case 2] The callee enters a number (e.g., types ‘20’) into the Take Message edit box and selects it. In response, PVA 202 may proceed to take a structured voicemail from the caller, and tells the caller that the callee will return his call within the callee-specified (in the example, within 20 minutes) reply time. [Case 3] The callee leaves the edit box empty, and selects the Take Message option. In response PVA 202 may proceed to take a structured voicemail, and does not specify a reply time to the caller. [Case 4] The callee selects Option 2 (Transfer call). In response, PVA 202 may proceed to the Call Transfer function, with destination being the destination specified by the callee.

If the PVA user is at his/her desk, on the telephone but not logged onto his computer, the PVA 202 may ring the telephone with a special ring denoting that there is a second incoming call (call waiting ring). The callee (PVA user) may put his first caller on hold. In response the PVA 202 may indicate to the callee that he has a call from the confirmed identity caller and indicate (if collected) the urgency classification of the call, e.g. PVA: “[name of caller] is calling and he says it is urgent.” The callee may respond as described above. If the PVA user is not at his/her desk but is logged onto his computer, PVA 202 may display a popup on the callee's computer screen, such as “[name of caller] is calling and he says it is urgent. Should I (1) Forward his call to your mobile (2) Take a message and tell him you will call back in [N] minutes (3) Transfer the call to [person specified by PVA user]?” [Case 1] If the callee selects option 1, PVA 202 may proceed to Forward Call processing. In response to this selection, PVA 202 may forward the call to the PVA user's mobile telephone. [Case 2] The callee selects Option 2 or 3. In response to these selections, PVA 202 may proceed to take a structured voicemail or perform Call Transfer processing, respectively. If the PVA user is not at his/her desk, is not logged onto his computer and receives an urgent call, the PVA 202 may discover via presence processing that the callee cannot be alerted via the PVA, and may proceed to the Caller Election phase.

If the caller is limited to leaving a structured voicemail by the user-specified rules, the PVA 202 may tell the caller that the callee is not at his desk, and that the caller can leave a message, e.g., PVA: “I'm sorry, but [callee name] is not at his desk, so I'll take a message for him, and he will get back to you as soon as he can.” If the caller is permitted by the user-specified rules to elect to forward a call, the PVA 202 can indicate to the caller that his call can either be forwarded to the callee's mobile communications device or he can be sent an alert, e.g. PVA: “I'm sorry, [name of caller], but [name of callee] is not at his desk. Would you like me to forward your call to his mobile, or take a message here and send him an alert?” [Case 1] If the caller opts to leave a message, the caller may say so and PVA may proceed to structured voicemail handling. [Case 2] If the caller opts to forward the call, the caller may say so: e.g., Caller: “Please forward the call.” and PVA may proceed to forward the call to callee's mobile number.

PVA 202 may also dispose of a call by transferring the call. PVA 202 may transfer a call to a single number or may dispose of the call by selecting from a list of numbers to which to transfer the call. Suppose for example, that the PVA user (the callee) will be out of the office for some period of time and wants the PVA to dispose of the call based on the subject matter of the incoming call. When a call comes in to the callee's number, PVA 202 may play a prompt recorded by the PVA user for this purpose, e.g. Bill: “I'm out of the office until June 15. For schedule questions, contact Ray. For beta questions, speak with Alex. For M4 questions, talk to Chris. For all other issues, please ask to speak with Kathleen, or leave a message which I will get when I return. How shall I direct your call?” PVA 202 may process the caller's reply and transfer the call based on the recognized name or key word in the caller's response; e.g., Larry: “Oh, um, put me through to Ray.” In response to detecting the word “Ray” PVA may respond with a message such as PVA: “Please wait while I transfer your call to Ray.” The person to whom the message is transferred may be a PVA user, and thus the call transferred to “Ray” may itself be handled by a PVA. PVA: “Larry, please wait while I establish an IVM session with Ray . . . OK, please speak your message clearly.”

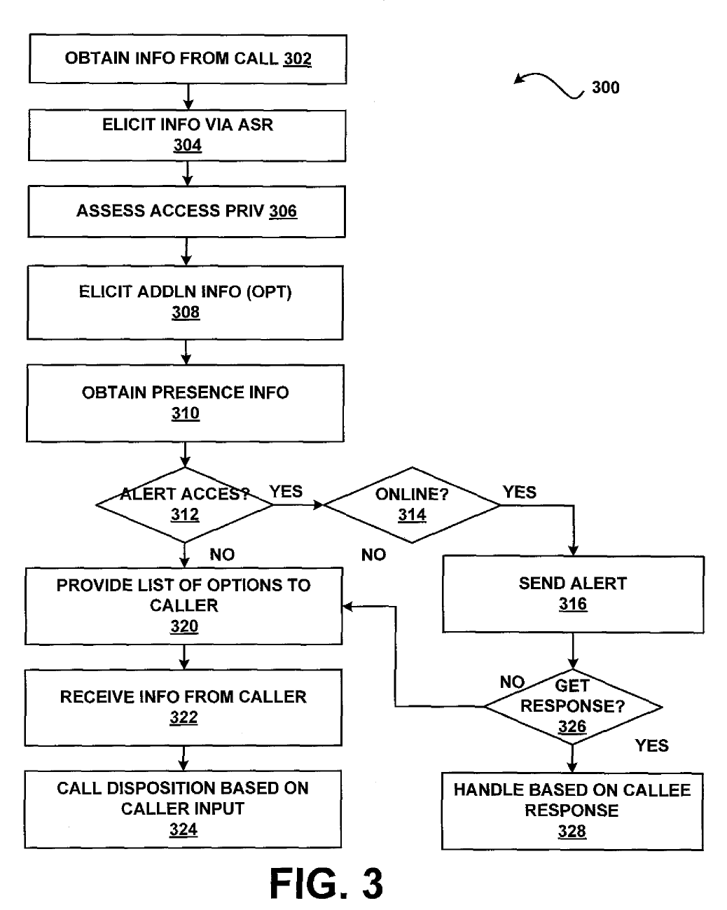

FIG. 3 is an exemplary flow diagram of a method 300 for incoming call classification and disposition in accordance with embodiments of the invention. At 302 caller information is received. Caller information may include information such as ANI information, DNIS (dialed number identification service) information, SIP invite address or other information. At 304 additional information may be elicited from the caller using automated speech recognition processing. If the information received at 302 and 304 is sufficient, this information may be used to look up the rules-defined access privileges for the caller (306). In some embodiments of the invention, the caller telephone number is looked up in the contact list. The contact list may include caller telephone number, caller name, the group (e.g., Family, Supervisor, Customer, etc.) to which the caller belongs. Based on belonging to a particular group, special rules (from rules database 210) may be applied. At 308, based on the access privileges, additional information may be requested from the caller. For example, if the caller belongs to a Family group, the caller may be prompted for call classification information such as urgency of the call. Rules in the rules database may be based on this classification. For example, an urgent call from a Family member may receive some kind of preferential treatment, as specified in the rules for this type of call from this type of caller. At 310, callee presence information is obtained. Presence information can be obtained by information concerning whether the PVA user is logged onto his computer, whether or not the PVA is logged onto an interactive text messaging application, information available from a scheduling or calendar application. At 312 it is determined if the callee has access to user alert. If the callee does have access to user alert and the callee is on-line (314), an alert is sent (316). If callee input is received specifying the call disposition desired (326), the call is handled according to the callee input (328). If no callee input is received after a specifiable time period or the callee does not have access to user alert, at 320, the caller is provided with a list of whatever choices are enabled by the access privileges of the caller. These may include forward call, voicemail, transfer to another number, instant voice messenger and so on as described above. The caller's choice is obtained using automated speech recognition (322). At 324 the call is handled according to the caller input.

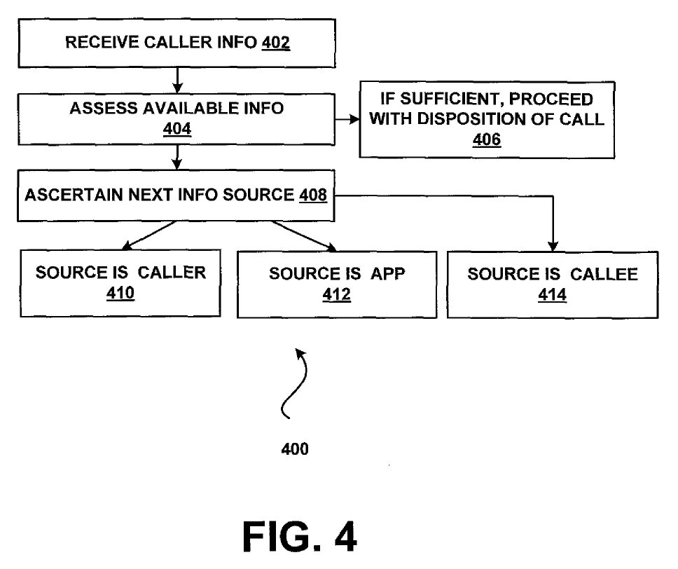

FIG. 4 is another method 400 of call classification and disposition in accordance with embodiments of the invention. At 402 caller information is received. At 404, available information according to PVA user-configurable rules are assessed. If enough information is available to make a final call disposition, that disposition is enacted (406). At 408, if there is not enough information to make a call disposition decision, the source and nature of the next information to obtain is determined. At 410, if the next source of information should come from automated speech recognition dialog with the caller, the information elicited from the caller may include caller name, call urgency, call topic and so on. If the next source of information should be presence information of the callee, at 412 information may be elicited from available APIs (computer logon information, active process information). At 414 if the next source of information should come from the callee, an interactive text messaging session may be initiated with the callee. The information elicited from the callee may include the way the call should be handled. Alternatively, if the next source of information should be from the callee, a second telephone call may be initiated with the callee in which the way the call should be handled is elicited from the callee. Alternatively, if the next source of information should be from the callee, an application such as a web application or other application may be initiated for the callee and information entered by the callee/processed by the application may be returned to the PVA.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed:

1. A system for classification and routing of incoming calls comprising:
a personal virtual assistant hosted on an enterprise communications server that classifies and routes an incoming telephone call from a caller to a callee, the callee comprising a personal virtual assistant user, wherein the incoming telephone call is routed to a telephone communications device or to a computer of the callee based on information received from a contact datastore, information received from a presence server that determines a location of the callee based on computer logon information for the callee and on information from at least one rules datastore; and
the at least one rules datastore comprising enterprise-wide and caller-specific rules for handling the incoming telephone call to the callee.

2. The system of claim 1, wherein the incoming telephone call comprises a first communication channel and wherein the personal virtual assistant automatically initiates a second communication channel with the callee while the incoming telephone call is being processed.

3. The system of claim 2, wherein the incoming telephone call is routed to the callee's computer when presence information for the callee indicates that the callee is logged onto the callee's computer.

4. The system of claim 2, wherein the incoming telephone call is routed to a telephone of the callee when the callee's presence information indicates that the callee is by the callee's telephone.

5. The system of claim 2, wherein a communication mode comprising voice or text is selected based on the callee's presence information.

6. The system of claim 1, further comprising an automatic speech recognition component that gathers information concerning the incoming telephone call from the caller.

7. The system of claim 6, wherein the information gathered by the automatic speech recognition component is used to process the incoming telephone call.

8. The system of claim 1, further comprising an automatic speech recognition component that offers call disposition options to the caller based on information from the presence server, contact datastore and the at least one rules datastore.

9. A method of telephone call classification comprising:
receiving information about a caller over a first communication channel, wherein the information is gleaned from an automated speech recognition (ASR) processed dialog with the caller during a telephone call;
using the received information to classify the caller and to ascertain access privileges of the caller to the callee based on caller-specific rules for the callee;
retrieving a location of the callee based on presence information;
initiating a second communication channel based on the location of the callee, wherein the callee is prompted for call disposition information.

10. The method of claim 9, further comprising receiving information about the caller from ANI (Automatic Number Identification) information received from a telephone system.

11. The method of claim 10, wherein the ANI information is used to determine a tentative identity of the caller.

12. The method of claim 11, wherein the tentative identification of the caller is verified by an automated speech recognition (ASR) processed dialog with the caller during the telephone call.

13. The method of claim 12, wherein the verified identification of the caller identifies the caller as a member of a group, wherein the group is associated with group-specific call disposition rules.

14. The method of claim 9, wherein presence information is obtained from computer logon information, from active process information, from a scheduling application or from a calendar application.

15. A computer-readable storage medium comprising computer-executable instructions that when executed cause a computer environment to:
receive information about a caller making a telephone call to a callee over a first communication channel, wherein the information is gleaned from an automated speech recognition (ASR) processed dialog with the caller;
retrieving a location of the callee based on presence information retrieved from computer logon information or active process information;
handling the telephone call based on caller-specific rules in a datastore for the callee.

16. The computer-readable storage medium of claim 15, comprising further computer-executable instructions that when executed cause the computer environment to:
initiate a second text or voice communication channel based on the location of the callee, wherein the callee is prompted for call disposition information for the telephone call.

17. The computer-readable storage medium of claim 15, comprising further computer-executable instructions that when executed cause the computer environment to:
receive information about the caller from a telephone system.

18. The computer-readable storage medium of claim 15, comprising further computer-executable instructions that when executed cause the computer environment to:
use the information received about the caller to determine a group to which the caller belongs.

19. The computer-readable storage medium of claim 18, comprising further computer-executable instructions that when executed cause the computer environment to:
process the call based on group-specific rules.

20. The computer-readable storage medium of claim 15, comprising further computer-executable instructions that when executed cause the computer environment to:
determine a type of the call and route the call based on the determined type.
